(19) United States
(12) Patent Application Publication
(10) Pub. No.: US 2010/0063688 A1
(43) Pub. Date: Mar. 11, 2010

(54) DEVICE FOR INCREASING THE DOWNWARD FORCE OF A CAR

(76) Inventor: Frantisek Hrabal, Praha (CZ)

Correspondence Address: PERKINS COIE LLP, P.O. BOX 1208, SEATTLE, WA, 98111-1208, US

(21) Appl. No.: 12/532,612

(22) PCT Filed: Mar. 21, 2008
(86) PCT No.: PCT/CZ08/00033

§ 371 Date: Sep. 22, 2009

(30) Foreign Application Priority Data
Mar. 22, 2007 (CZ) PV 2007-216

(51) Int. Cl. G06F 17/00; B60G 17/015; B60T 8/172

(52) U.S. Cl. 701/48; 280/5.503

(57) ABSTRACT

The invention concerns a device for increasing the downward force pressing a car to the road, mainly while braking, accelerating, or turning, consisting of a wheel hub, at least one control arm, a brake system, and a damping unit. The brake system consists of a brake drum and brake shoes or a brake disc and brake pads mounted on a caliper. At least one brake shoe and/or caliper and/or brake pad and/or additional mass element is placed in a pushing plane parallel with at least one tangent to the circle or on the segment of a circle with the same center of rotation as the wheel hub and where the trajectory of movement is limited by at least one brake stop.

### TECHNICAL FIELD

A device is described that increases the downward force that a car applies against the surface of the road, especially during braking, accelerating, or turning. The suspension system, the wheel hub, at least one control arm, and the brake system are involved.

### BACKGROUND OF THE INVENTION

Two different types of brake system are currently in use, drums and discs. There are also spin regulation systems, known as ASR (anti-spin regulation), which ensure that torque is transmitted to wheels that have traction on the road and not lost to wheels that are slipping. These consist of the wheel hub, at least one control arm, the suspension system, and the brake system itself.

A disc brake system consists of a brake disc and two caliper-mounted brake pads that can be forced to grip the disc between them. Drum brakes are made up of two brake shoes that can be forced against the inner surface of a brake drum. Braking then occurs as the applied force increases the friction between the pads and the disc or the shoes and the drum, respectively. The braking power can be as much as ten times the power of the car engine. The braking force acts in the direction of rotation of the wheel, and almost all of the energy is released as heat which must be dissipated in the external environment.

The total braking effect depends on the coefficient of friction between the tire and the road and the force pressing the tire against the road. This downward force is created mainly by the weight of the car acting on the particular wheel.

A particular disadvantage of the existing systems is the fact that the energy absorbed by the brakes is wasted in the form of heat. Also, the current brake systems and ASR are unable to optimize the downward force pressing the tire to the road to maximize adhesion when it is most needed or to store energy when maximum adhesion is not required. Contemporary devices such as ESP or ABS can increase steering control and improve braking on wet surfaces by momentarily releasing the brakes, but these are relatively intricate systems.

### SUMMARY OF THE INVENTION

The above-mentioned disadvantages are greatly diminished by using a new device to increase the downward force pressing the car to the road, especially while braking, accelerating, or turning. This technical solution depends on at least one to brake shoe and/or caliper and/or brake pad and/or additional mass element being placed in a pushing plane parallel with at least one tangent to the circle of rotation of the wheel or on a segment of a circle with the same center of rotation as the wheel hub, where the trajectory of motion is limited by at least one brake stop.

During braking, at least one brake shoe and/or caliper and/or brake pad and/or additional mass element will be drawn temporarily along this tangent or segment, and this movement can be used to increase the downward force pressing the tire to the road. The trajectory of this movement is limited by brake stops with fixed or variable travel lengths.

At least one brake shoe and/or caliper and/or brake pad and/or additional mass element is temporarily connected with the brake disc or brake drum.

At least one brake shoe and/or caliper and/or brake pad and/or additional mass element is effectively connected with an additional linear activator to extend the length of the suspension unit while braking. At least one brake shoe and/or caliper and/or brake pad and/or additional mass element can be fitted with a lock.

This technical solution also concerns a device wherein the suspension unit is fitted with at least one additional linear activator connected with an actuator and allowing the suspension system to lengthen or spring up during braking. An additional thrust spring can be connected to the dampening unit.

If at least one brake shoe and/or caliper and/or brake pad and/or additional mass element is mounted on a swivel with the same axis of rotation as the brake disc or drum, it will be drawn along with this disc or drum. In this case, the freedom of movement of at least one brake shoe and/or caliper and/or brake pad and/or additional mass element will be limited to 10 degrees by the brake stops, and at least one brake shoe and/or caliper and/or brake pad and/or additional mass element will cover a distance of 10 mm within these 10 degrees. At least one brake shoe and/or caliper and/or brake pad and/or additional mass element can thus perform effective work in the given range. This movement, transferred by a lever on the axle, draws the body of the car away from the wheel by as much as 10 mm, thereby increasing the downward force pressing the tire to the road. This simple mechanism thus makes it possible to considerably increase the adhesion of the tire for a short time. In this way, the tire can overcome a critical moment when, for example, aquaplaning might otherwise occur. The retraction of at least one brake shoe and/or caliper and/or brake pad and/or additional mass element can also be postponed by using a lock or spring is that will delay the start of another drawing phase until a more suitable time or slow down the drawing itself. Alternatively, a lock can be used for the related parts connected. Despite the fact that at least one brake shoe and/or caliper and/or brake pad and/or additional mass element will then be drawn, this motion will not be transferred to the lever until the time is right. The movement of at least one brake shoe and/or caliper and/or brake pad and/or additional mass element and the transfer of movement to the lever can also be permitted just before the wheel locks up; however, at least some adhesion of the rotating wheel must be ensured in order for the device to work properly. The greater the positive torque in the direction of the shift of at least one brake shoe and/or caliper and/or brake pad and/or additional mass element is during the braking of a given wheel, the greater will be the potential of the device to increase the downward force.

A brake stop is represented by any method of limiting the extent of movement or any method of slowing down the movement of at least one brake shoe and/or caliper and/or brake pad and/or additional mass element along the tangent or the segment of a circle. The freedom of movement of at least one brake shoe and/or caliper and/or brake pad and/or additional mass element can then be limited, for example, by the freedom of movement of a connected lever or activator.

When the brake is released, the brake shoes or brake pads will retract from the drum or disc, respectively, and at least one brake shoe and/or caliper and/or brake pad and/or additional mass element will turn back the 10 degrees to its rest position. The whole body of the car will sag by 10 mm, and the downward force pressing the tire to the road will decrease momentarily. The downward force thus decreases when no braking is taking place and maximum downward force is not needed. However, it is possible to block or slow down the return of at least one brake shoe and/or caliper and/or brake pad and/or additional mass element to the rest position, or to reduce or postpone decreasing the downward force, e.g., while turning, when such a loss of force could be dangerous.

A principle inverse to the above-mentioned method can also be used. The movement of at least one brake shoe and/or caliper and/or brake pad and/or additional mass element can, by means of a lever, reduce the separation between the wheel and the body of the car by 10 mm. The downward force of the wheel pressing against the road drops while this distance is decreasing. When this spatial separation reaches its minimum, the momentum of the sagging body of the car will momentarily increase the downward force pressing the tire to the road. When the brake is released, at least one brake shoe and/or caliper and/or brake pad and/or additional mass element will be returned to its rest position, e.g., by a spring. Similarly, the body of the car will return to its original spatial separation from the wheel and the downward force will increase.

If only a short pulse occurs when the force from at least one brake shoe and/or caliper and/or brake pad and/or additional mass element is quickly transferred between the body of the car and the axle, this pulse will cause the parts between the body of the car and the axle to spring up, and thus momentarily increase in the downward force. This will happen despite the fact that such a pulse leads to only a minimal change in the spatial separation of the wheel and the body of the car, and it dissipates before transferring its effect to the body of the car to any extent. With respect to the braking power and the shortness of the pulse, a relatively large amount of energy can be put into it.

The mass alone of at least one brake shoe and/or caliper and/or brake pad and/or additional mass element gives rise to action and reaction forces. If the mass of at least one brake shoe and/or caliper and/or brake pad and/or additional mass element is drawn upwards with the brake disc or drum, it will give rise to a reaction force on the wheel pointing towards the road and increase the downward force. Also, if the mass of at least one brake shoe and/or caliper and/or brake pad and/or additional mass element is rapidly restrained by a brake stop or spring while it is moving towards the road, the downward force of the wheel will also be increased. In this way it is possible to increase the downward force without inserting a linear activator.

The above-mentioned methods can be used to increase the downward force pressing the tire to the road, or this energy can be stored from the start of the application of the brakes or at any time during the application of the brakes. Interconnecting it with an ABS will increase the advantages of this device. While the brakes are applied, the braking effect will be increased by the above-mentioned pulse; the wheel is then released briefly, and the cycle repeats. The advantage is that in the case of non-critical braking, the system goes through only one pulse at the start of braking and resets when the brakes are released. In the case of critical braking, however, the system generates pulses repeatedly and increases the downward force repeatedly. It is then possible to set the force of the pulse to a more effective value, which can be noticed even inside the car, as vibration or noise, for example. Inasmuch as this will occur only during all-out, critical braking, it should not matter too much. Moreover, this potential discomfort will warn the driver that he or she is driving at the limit of safety. Such a warning may be useful in these days when safety systems prevent the driver from feeling feedback from the car even in critical situations. The system can even be set so that the first pulse will activate only after the ABS has been activated and not at the first touch of the brake pedal. Effectively, the system can also be used by other safety or control systems, such as ESP (Electronic Stabilization Program) or ASR (Anti-Spin Regulation).

When the adhesion drops, the force acting between the wheel and the road might not be enough to shift at least one brake shoe and/or caliper and/or brake pad and/or additional mass element and create a pulse. Nevertheless the momentum of the rotating wheel can shift the brake shoes, caliper, or brake pads even in this case. Even a relatively small pulse can be crucial and can provide for contact of the tire with the adhesive layer of the road at the crucial time. Moreover, even a relatively small force can be multiplied by concentrating it into the shortest possible time interval.

If at least one brake shoe and/or caliper and/or brake pad and/or additional mass element is drawn briefly at the start of braking, the load on the brake parts will increase more slowly than if nothing were drawn.

The pulse need not necessarily be released in the subsequent cycle nor stored only in modified height of the body of the car. It can also be stored in other ways, e.g., in a spring, from which it can then be released at the required moment, e.g., just at the start of a bend in the road, when such a pulse can permit a higher speed to be maintained. It can also be released during acceleration to ensure better traction and faster acceleration of the car.

The above-mentioned examples use the brake shoes, calipers or brake pads. These can be replaced by any system firmly connected with the brake shoes or temporarily connected with the brake disc, brake drum, or another part of the wheel.

A linear activator makes it possible to change the spatial separation between the wheel and the body of the car or increase the force pressing the tire to the road while drawing the body of the car away from the wheel. Using a simple mechanism, it is thus possible to considerably increase the force pressing the tire to the road for a short time. In this way, the tire can overcome a critical moment when, for example, aquaplaning might otherwise occur. The motion of this linear activator can also be postponed until a more suitable time by using, e.g., a lock or spring which slows down or delays its movement. The brake is then released, and the whole body of the car sags back to its original position, momentarily reducing the downward force pressing the tire to the road. This decrease takes place while the brakes are not applied and the downward force is not needed to such extent or when the ABS has unblocked the wheel, which is then rolling freely until the next activation of the brakes. It is also possible to lock out the return of the linear activator to its original position and avoid having the body of the car sag while turning, a time when a loss of downward force could be dangerous.

The device described above is unsophisticated and therefore cheaper and much less maintenance-intensive than the currently existing solutions. In addition, it can improve the function of an anti-spin regulation device (ASR).

Connecting this device with the established safety systems will combine their individual effects. The suggested device can, however, also be fully mechanical; without electronic elements it would be even safer in case any electronically controlled elements should fail.

### BRIEF DESCRIPTION OF THE DRAWINGS

A device for increasing the downward force pressing a car to the road, especially while braking, accelerating, or turning, is described in technical detail in the attached drawings of particular examples.

FIG. 1 presents a side-view schematic depiction of the standard arrangement of the device.

FIG. 1b shows the brake caliper, including the brake pads, mounted on a swivel.

FIG. 1c shows this system while braking.

FIG. 1d shows this system after the end of braking.

FIG. 2a shows an assembly where the rod connecting the suspension unit with the axle is divided into two parts.

FIG. 2b shows the assembly shortly after reaching the second limit position of the caliper.

FIGS. 3a, 3b, and 3c show the assembly fitted with a brake stop.

FIGS. 4a and 4b show the arrangement with an auxiliary bracket.

FIGS. 5a, 5b, and 5c show the arrangement of the brake pad on a circular path, and

FIGS. 6a, 6b, and 6c show the arrangement of the brake pad on a linear path.

### EXAMPLES OF THE INVENTION

The proposed device for the increasing the downward force pressing a car to the road, especially while braking, accelerating, or turning, consists of the wheel hub, at least one control arm, the brake system, and the suspension unit 3, wherein the brake system consists of a brake disc 1 and brake pads or a brake drum and brake shoes, respectively. The brake pads (or shoes) are connected to a swivel with the same axis of rotation as the wheel hub and freedom to move no more than 10 degrees.

This swivel is connected to an auxiliary linear activator to change the length of the suspension unit 3 while braking. It is also fitted with a lock.

### Example 1

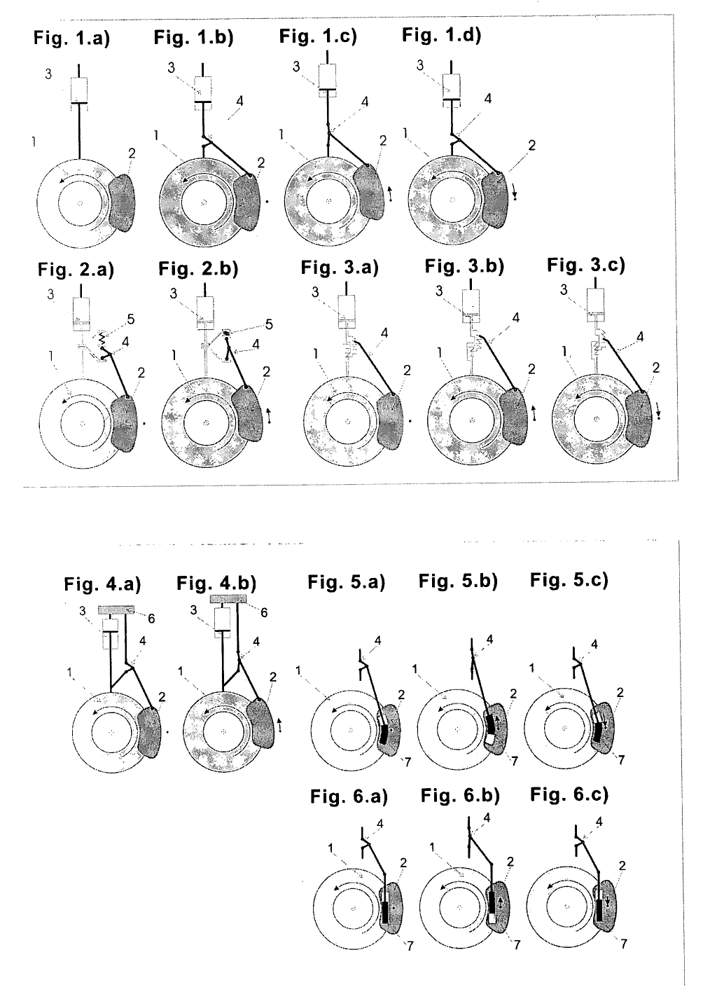

FIG. 1a shows a schematic depiction of the standard assembly. This assembly includes the brake disc 1, the brake caliper 2 containing the brake pads 7, and the suspension unit 3. As a standard, the suspension unit 3 is connected to the wheel hub at the bottom and to the body of the car 6 at the top. The suspension unit 3 usually consists of a damper in an assembly with a spring 5. The wheel hub carries the wheel and the brake disc 1. The brake caliper 2 is firmly connected to the stationary part of the hub or to the wheel suspension unit 3, and basically has no freedom of movement in the direction of rotation of the disc 1.

FIG. 1b shows the same assembly as FIG. 1a with the following difference. The brake caliper 2 containing the brake pads 7 is mounted on a swivel which allows the caliper 2 to move along with the brake disc 1. The caliper 2 is connected to the suspension unit 3 through a lever system 4; when the caliper 2 moves towards the suspension unit 3, the lever extends the suspension unit 3. The caliper 2 is shown at the limit of its movement; the lever does not allow it to move further away from the suspension unit 3. So the lever acts as a brake stop.

FIG. 1c shows the system while braking. The caliper 2 has been drawn along the arrow into the second limit notch, causing the lever to extend the suspension unit 3 and resulting in an increase in the downward force pressing the particular wheel to the road. The caliper 2 is shown at its limit position, and the lever prevents it from getting any closer to the suspension unit 3.

FIG. 1d then shows the return of the caliper 2 along the path shown by the arrow and thus also the return of the whole system to its original state before the start of another cycle.

The suspension unit 3 consists mainly of a vibration damper and a spring 5. The stem of the lever in the suspension unit 3 can lead to either a springing-up of the suspension unit 3, or its immediate or gradual extension. Both of these increase immediately or gradually the downward force pressing the wheel to the road.

Although the individual examples can then vary according to the set-up of the particular brake system, the stem of the lever will have different effects in as much as it acts on different parts of the suspension unit 3. If the lever acts on the spring 5, this will cause the system to spring up relatively immediately, whereas if it acts on the damper, the system will relatively immediately extend. In some cases, depending on the required quickness of the increase in the downward force and the required duration of this action, it can then be more advantageous if the lever acts on only one part of the brake system.

### Example 2

FIG. 2a shows the assembly where the rod connecting the suspension unit 3 with the axle is divided into two parts. These two parts are connected by a lever and spring 5 pulling them towards each other. While braking, the caliper 2 is drawn and the lever compresses the spring 5. The spring 5, subsequently forces the two parts of the rod away from each other, thus increasing the downward force acting on the wheel.

FIG. 2b shows the assembly shortly after reaching the second limit position of the caliper 2. The lever has compressed the spring 5, and the parts of the rod have already separated slightly. This example describes a separate spring 5, but it is possible to use the spring 5 which is a standard part of the suspension unit 3, as described in the previous example. A separate spring 5 is effective when the springing-up caused by the brake requires suspension characteristics other than those delivered by the standard spring 5 of the suspension unit 3.

Likewise, the activator interconnected with the suspension system allows the system to spring up quickly because of the different suspension characteristics of the activator and the suspension unit 3. The damper then damps down the transmission of vibrations caused by the linear activator to the body of the car 6 and so increases passenger comfort.

### Example 3

During interrupted braking, e.g., using an ABS, a greater downward force phase alternates with a release phase. Current anti-blocking systems can interrupt braking up to 16 times a second. Such short intervals are not necessarily sufficient to optimize the increase of the downward force and its subsequent release. This can be to prevented by decreasing the number of ABS cycles or by locking the device for a period of several subsequent pulses. Thus, for example, the suspension unit 3 can spring up with the first pulse and then release energy over the period between the second and fifth ABS cycles thereby altering the spatial separation of the body of the car 6 from the wheel. During the sixth pulse the system will then be released and it will return to its original state. The system can be forced to return, i.e., accelerated, e.g., by pressure or by the pull of the spring 5. The return can also be divided among several ABS cycles and be completed over several brake releases.

It is likewise possible to generate only the increase of the downward force during several ABS cycles. FIG. 3a shows the assembly fitted with a brake stop. FIG. 3b then shows this assembly with the caliper 2 already drawn along the path shown by the arrow and the suspension unit 3 extended by the lever. The suspension unit 3 remains extended even when the caliper 2 has returned to its original position, as shown in the FIG. 3c. At the same time, the lever has moved one notch lower on the suspension unit 3, and the next drawing of the caliper 2 may lead to a further extension of the suspension unit 3. It is possible to set both the release of the locked brake stop and the full or partial return of the whole system to its original state for any time after an extension step.

### Example 4

When adhesion is weak, e.g., during aquaplaning, a quick pulse, as strong as possible, can be advantageous; this will ensure that the tire breaks quickly and immediately through the layer of water on which has been slipping. Once through the layer of water, the tire starts to brake against the surface of the road. In contrast, a slower pulse that is less strenuous for the system and releases the downward force steadily over a longer period of time can be more advantageous on a road where adhesion is strong. It is then convenient if the system is able to change the downward force as needed. The adjustable brake stops allow for contraction or extension of the segment along which the caliper 2 can be drawn with the brake disc 1. So it is also possible to increase or decrease the amount of energy that is generated and available to increase the downward force.

The increase of the downward force can be delayed even within one braking cycle. At the start of the cycle when there is still sufficient adhesion, the caliper 2 is not drawn. The lock will not allow it to be drawn until the adhesion starts to drop. When the lock is released, the downward force will increase.

The coefficient of friction can also increase. This can happen when the increased downward force causes the tire to break through, e.g., a layer of snow upon which had been slipping, and start to brake against the wet surface of the road. A wet road has a higher coefficient of friction than snow.

The lock can be switched on, e.g., by a computer or an ABS, or it can have a simple, built-in delay mechanism that switches it on at certain time after the start of braking.

### Example 5

FIG. 4a shows the brake caliper 2 containing the brake pads 7. It is mounted on a swivel that allows the caliper 2 to move along the brake disc 1. The caliper 2 is connected to a lever system 4, and the lever extends the bracket 8 that connects the body of the car 6 to the axle while the caliper 2 is moving, as shown in FIG. 4b.

### Example 6

The braking energy can be drawn directly from the motion of the individual brake pad 7. FIG. 5a shows a sectional view of a caliper 2 that includes a brake pad 7 free to move along part of a circle co-axial with the brake disc 1. While braking, the brake pad 7 is pressed to the brake disc 1 and is drawn along with it in the direction of the rotation of the brake disc. While moving along the path shown by the short arrow, it acts on the lever, as shown in FIG. 5b. When the brake is released, the pad 7 will return to its original position, moving in the direction opposite that of the rotation of the brake disc, as shown on the FIG. 5c.

### Example 7

The brake pad 7 need not move only along a circular path. It can move along any path that intersects the surface of the brake disc 1, if a sufficient surface area of the brake pad 7 is touching the brake disc 1. FIGS. 6a, 6b, and 6c show an example similar to example 6 but with a different path of the brake pad 7. While moving along the surface of the brake disc 1, the brake pad 7 moves along a line. Basically, any path of the brake pad 7, or the brake system interconnected with it that intersects the surface of the brake disc 1 is possible, not only circular or linear.

If a system made up of the brake pads or the brake caliper 2 or both is mounted on a swivel with an axis of rotation identical with the axis of rotation of the brake disc 1 and the wheel hub, it will be drawn with this disc 1. In this example, the freedom of movement of the caliper 2 is limited to 10 degrees by the brake stops, and within these 10 degrees the movement of caliper 2 will cover a distance of 10 mm. The brake caliper 2 can perform effective work while moving in this range. Transferring its movement between the axle and the body of the car 6 by means of a lever will draw the body of the car 6 away from the wheel, e.g., by 10 mm, or increase the downward force pressing the tire to the road or both. Using a simple mechanism, it is thus possible to considerably increase the cohesive force of the tire for a short time. In this way, the tire can overcome a critical moment when, for example, aquaplaning might otherwise occur. The drawing of the brake caliper 2 can also be delayed until a more suitable moment, e.g., by using a lock or spring 5 that delays drawing until a more suitable time or slows down the drawing itself. Alternatively, a lock can be used for the related parts connected. Despite the fact that the caliper 2 will then be drawn, this movement will not be transferred to the lever until a suitable time. It is also possible to allow the caliper 2 to move or to transfer its movement to the lever just before the wheel locks up; however, for this to work properly, the wheel must have some adhesion or rotational momentum. The greater the positive torque a given wheel has in the direction the brake pads shift during braking, the greater is the potential of the device to increase the downward force.

The brake stop is represented by any method of limiting the duration of the movement of the caliper 2 along the segment or any method of slowing down the movement of the caliper 2 along the tangent or segment. The freedom of movement of the caliper 2 can then be limited, e.g., by the movement of a lever connected to the caliper 2 or by the movement of a connected activator.

The brake stop is represented by any method of limiting the extent of movement or of slowing down the movement of at least one brake shoe and/or caliper and/or brake pad and/or additional mass element along the tangent or segment of a circle. The freedom of movement of at least one brake shoe and/or caliper and/or brake pad and/or additional mass element can then be limited, for example, by the freedom of movement of a connected lever or by the freedom of movement of a connected activator.

After the brake is released the brake pads will retract from the disc 1 and the caliper 2 will turn back the 10 degrees to its original position. The whole body of the car 6 will sag by 10 mm and the downward force pressing the tire to the road will drop briefly. The downward force decreases during the period when the car is not braking and less force is needed. However, it is possible to block or slow down the return of the caliper 2, or the parts connected with it, to the rest position or to reduce or delay decreasing the downward force while turning, when such a decrease could be dangerous.

The mass alone of the brake caliper 2 gives rise to action and reaction forces while moving. If the mass of the caliper 2 is being lifted up towards the top turning point by the brake disc 1, it will cause a reaction force on the wheel pointing towards the road and thus increase the downward force. Moreover, if the mass of the caliper 2 in motion towards the road is rapidly slowed down by a brake stop or a spring mounted on the wheel, this will also increase the downward force. In this way it is possible to increase the downward force without inserting a linear activator.

The above-mentioned methods can increase the downward force pressing the tire to the road or this energy can be stored at any time the brake pads are pressing against the disc 1 or the brake shoes are pressing against the drum, respectively. Interconnecting with an ABS increases the advantages of this device. For as long as the brakes are applied, the braking effect will increase by the above-mentioned pulse; the wheel will be released briefly while not braking, and the cycle will then repeat. The advantage is that, in the case of non-critical braking, the system goes through only one pulse at the beginning of braking and releases only when the brakes are released. For critical braking, however, the system generates pulses continually. It is then possible to set the pulse force to a more effective value which can be noticed even inside the car, for example, in the form of the vibrations or noise. In as much as this occurs only during critical braking, it should not matter too much. Moreover, this potential discomfort will warn the driver that he or she is driving at the limit of safety. Such a warning may be useful in these days when safety systems prevent the driver from feeling feedback from the car even in critical situations. The system can even be set in such a way that the first pulse will switch on only after the ABS has been activated and not at the first touch of the brake pedal. Effectively, the system can also be used by other safety or control systems such as ESP (Electronic Stabilization Program) or ASR (Anti-Spin Regulation).

### INDUSTRIAL UTILIZATION

This device for increasing the downward force pressing a car to the road, mainly while braking, accelerating, or turning, should, according to this technical solution, find applications especially in the production of new cars but also in the modification of existing cars.

1-8. (canceled)

9. A system for changing the downward force of a car on a surface, the system comprising a wheel hub, a suspension unit, and a brake unit, wherein the brake unit comprises a traveling mass element and a rotating part, further wherein the traveling mass element is configured to travel in a path around a wheel axis of the wheel hub, and further wherein the trajectory of movement of the traveling mass element is limited by a brake stop.

10. The system of claim 9, wherein the path is substantially parallel to a tangent to a circle sharing the wheel axis.

11. The system of claim 9, wherein the path is substantially parallel to a section of a circle sharing the wheel axis.

12. The system of claim 9, wherein the path comprises a line.

13. The system of claim 9, wherein the path comprises a curve.

14. The system of claim 9, wherein the traveling mass element comprises a brake shoe and the rotating part comprises a brake drum.

15. The system of claim 9, wherein the traveling mass element comprises a brake pad and a caliper and the rotating part comprises a brake disk.

16. The system of claim 15, wherein the brake pad moves and the caliper is fixed.

17. The system of claim 9, wherein a position of the brake stop is adjustable.

18. The system of claim 9 wherein the traveling mass element is interconnected with an additional linear activator that allows for the lengthening or springing-up of the suspension unit.

19. The system of claim 9 wherein the traveling mass element is interconnected with an additional linear activator that allows for the lengthening or springing-up of an element mounted between a body of the car and the wheel hub.

20. The system of claim 9, wherein the traveling mass element is fitted with a lock.

21. The system of claim 9, wherein the brake unit is configured for operation with a system selected from the group consisting of a brake pedal system, a steering wheel system, an ABS, an ESP system, an ASR system, and a computer system.

22. The system of claim 9, wherein the downward force of the car on the surface is decreased by a reaction force to a force of the rotating part towards the traveling mass element causing the traveling mass element as accelerated towards the ground.

23. The system of claim 9, wherein the downward force of the car on the surface is increased by the impact of a reaction force to a force of a rotating part towards the traveling mass element causing the traveling mass element to accelerate away from the ground.

24. The system of claim 9, wherein the downward force of the car on the surface is increased by the impact of the traveling mass element upon the brake stop when the trajectory of the traveling mass element is limited by the brake stop as the trajectory of the traveling mass is towards the ground.

25. The system of claim 9, wherein the downward force of the car on the surface is decreased by the impact of the traveling mass element upon the brake stop when the trajectory of the traveling mass element is limited by the brake stop as the trajectory of the traveling mass is in a direction away from the ground.

26. The system of claim 9, wherein the traveling mass element includes a traveling friction part.

27. A system comprising:
a suspension unit configured to couple a car body to a wheel unit, the suspension unit having a length that is adjustable, the wheel unit configured to rotate around a wheel axis;
a brake unit configured to reduce a rotation rate of the wheel unit during braking, the brake unit including a rotating part configured to be coupled to the wheel unit and further configured to rotate around the wheel axis, the brake unit further including a traveling mass element configured to frictionally contact the rotating part to reduce the rotation rate of the wheel unit during braking and further configured to travel in a path around the wheel axis while frictionally contacting the rotating part; and
an adjusting unit configured to couple the traveling mass element to the suspension unit, the adjusting unit further configured to adjust the length of the suspension unit by transmitting to the suspension unit a force exerted by the traveling mass element while traveling in the path.

28. The system of claim 27, wherein the traveling mass element comprises a brake shoe and wherein the rotating part comprises a brake drum.

29. The system of claim 27, wherein the traveling mass element comprises a brake pad mounted on a caliper and wherein the rotating part comprises a brake disk.

30. The system of claim 27, wherein the brake unit further includes a brake stop configured to limit the traveling mass element traveling in the path.

31. The system of claim 27, wherein a position of the brake stop is adjustable so that the path traveled by the traveling mass element can be adjusted.

32. The system of claim 23, wherein the adjusting unit adjusts the length of the suspension unit by increasing the length of the suspension unit to move the wheel unit further from the car body.

33. The system of claim 27, wherein the adjusting unit adjusts the length of the suspension unit by decreasing the length of the suspension unit to move the wheel unit closer to the car body.

34. A system comprising:
a suspension unit configured to couple a car body to a wheel unit, the suspension unit having a length that is adjustable, the wheel unit configured to rotate around a wheel axis;
a brake unit configured to reduce a rotation rate of the wheel unit during braking, the brake unit including a rotating part configured to be coupled to the wheel unit and further configured to rotate around the wheel axis, the brake unit further including a traveling mass element configured to frictionally contact the rotating part to reduce the rotation rate of the wheel unit during braking and further configured to travel in a path around the wheel axis while frictionally contacting the rotating part, the brake unit further including a brake stop configured to limit the traveling mass element traveling in the path.

35. The system of claim 34, wherein the traveling mass element comprises a brake shoe and wherein the rotating part comprises a brake drum.

36. The system of claim 34, wherein the traveling mass element comprises a brake pad mounted on a caliper and wherein the rotating part comprises a brake disk.

37. The system of claim 34, wherein a position of the brake stop is adjustable so that the path traveled by the traveling mass element can be adjusted.

38. The system of claim 34, wherein a downward force of the wheel unit on a surface is increased by the impact of the traveling mass element upon the brake stop when the trajectory of the traveling mass element is limited by the brake stop.

39. The system of claim 34, wherein a downward force of the wheel unit on a surface is decreased by the impact of the traveling mass element upon the brake stop when the trajectory of the traveling mass element is limited by the brake stop.

40. A method for adjusting the length of a suspension unit coupling a car body to a wheel unit, the method comprising:
frictionally contacting a traveling mass element of a brake unit onto a rotating part of a brake unit, wherein a rotation rate of the wheel unit is reduced;
traveling the traveling mass element in a path around a wheel axis of the wheel unit as a result of the frictionally contacting the traveling mass element;
transmitting to the suspension unit a force exerted by the traveling mass element as a result of the traveling; and
adjusting the length of the suspension unit utilizing the force.

41. The method of claim 40, wherein the traveling mass element comprises a brake shoe and wherein the rotating part comprises a brake drum.

42. The method of claim 40, wherein the traveling mass element comprises a brake pad mounted on a caliper and wherein the rotating part comprises a brake disk.

43. The method of claim 40, further comprising stopping the traveling of the traveling mass element against a brake stop.

44. The method of claim 40, wherein a position of the brake stop is adjustable so that the path traveled by the traveling mass element can be adjusted.

45. The method of claim 40, wherein the adjusting the length of the suspension unit comprises increasing the length of the suspension unit to move the wheel unit further from the car body.

46. The method of claim 40, wherein the adjusting the length of the suspension unit comprises decreasing the length of the suspension unit to move the wheel unit closer to the car body.

47. The system of claim 9, wherein the traveling mass element comprises a brake pad and the rotating part comprises a brake disk.
